(19) United States
(12) Patent Application Publication
(10) Pub. No.: US 2015/0207669 A1
(43) Pub. Date: Jul. 23, 2015

(54) DATA REDUNDANCY IN A DATA LAYERED ARCHITECTURE NETWORK

(71) Applicants: Jan Lemark, Stockholm (SE); Bo Åström, Stockholm (SE)

(72) Inventors: Jan Lemark, Stockholm (SE); Bo Åström, Stockholm (SE)

(73) Assignee: Telefonaktiebolaget L M Ericsson (publ), Stockholm (SE)

(21) Appl. No.: 14/424,329

(22) PCT Filed: Sep. 14, 2012
(86) PCT No.: PCT/EP2012/068163

§ 371 Date: Feb. 26, 2015

(51) Int. Cl. H04L 12/24; H04L 12/801; H04L 12/873

(52) U.S. Cl. CPC H04L 41/0654; H04L 47/52; H04L 47/12

(57) ABSTRACT

A method and apparatus for providing data redundancy in a data layered architecture network. An enhanced redundancy data backend node stores data designated as dynamic data in a first memory. It also stores data designated as static data in a second memory having a higher latency and/or higher volume than the first memory. Data therefore has a lower memory footprint, as only dynamic data need be regularly updated.

### TECHNICAL FIELD

The present invention relates to providing data redundancy in a Data Layered Architecture network.

### BACKGROUND

Current Public Land Mobile Networks (PLMN) typically comprise a radio access network and a core network. The radio access network is responsible for providing wireless access to network users, whilst the core network is responsible, inter alia, for subscriber service access control and subscriber roaming. In the case of 2G or GSM network, a typical PLMN comprises circuit switched (CS) core network for handling voice calls and a packet switched (PS) core network for handling data. A 3G or UMTS network similarly comprises PS and CS core networks, whilst a 4G or LTE network comprises only an Enhanced Packet Core (EPC) core network. In addition, service networks may co-exist with the PS and CS core networks. One such service network is the IP Multimedia Subsystem (IMS) network. The IMS network may also be considered as a core network. In practical implementations, subscribers may roam between different radio access networks, and services may be switched between core networks, e.g. a voice call may be switched from a 3G radio access network and CS core network to a 4G network, with the same IMS core network remaining in control of the session.

PLMN operators are always keen to reduce network signalling load for a given subscriber volume, to increase network resilience to failure, and to reduce the complexity and number of specialist network nodes. With this in mind, the 3GPP organisation has defined a so-called Data Layered Architecture (DLA) that splits the traditional node and network architecture introduced for GSM, UMTS and EPC in two halves; an application front end (Application-FE) that provides the logic for a node, and a Data back end (Data-BE) that provides data. This is illustrated in FIG. 1, in which the functionality of a node is split into an application layer and a data layer. The Data-BE provides a highly available and geo-redundant solution to the Application-FEs that simplifies the design of applications. DLA also simplifies the routing in the core networks since any node can, if it is built as a stateless FE, serve any subscriber. The principles and advantages of DLA can be summarised as follows:
Simplified routing to Application FEs in Core Networks
   Any Application FE can serve any subscriber
Data & Repository Consolidation
   Several applications use the same backend (repository consolidation)
   Data de-duplication by allowing several applications to access the same data object (data consolidation)
Scalable and Highly Available system
   Backend provides HA and Geo Redundancy
Simple scaling of Application Front Ends
Simplified Application Design
   Provisioning into back end database
   Dynamic allocation of subscribers to Application FEs
   Allows for stateless Application FE design
   Data Availability provided by the Backend

Consider the Home Location Register (HLR) that is implemented in 2G and 3G core networks and that acts as a central database for subscriber information. The HLR stores details of subscribers issued by the network operator. Typically, a network will comprise a number of HLRs, each of which is assigned to a group of network subscribers. An HLR provides subscriber information to other core network nodes, such as the 2G Mobile Switching Centre (MSC). In the traditional architecture, core network applications, such as the MSC, must identify and route signalling to the correct HLR (i.e. the HLR currently serving a given subscriber). According to the DLA architecture, an HLR-FE can serve any subscriber (i.e. all network subscribers) and network routing becomes very simple: the advanced Data-BE performs routing for the applications.

Other advantages of DLA include Data and Repository Consolidation allowing databases and data-object sharing, and simplified provisioning (and removal) of subscribers within the system.

A failure of the Data-BE would leave to a failure of HLR-FE services for all affected subscribers to (note that the same is true for FE applications that provide other services, HLR is provided by way of example only). In view of this, the Data-BE is provided with a number of availability and redundancy mechanisms. Examples of these include Synchronous and Asynchronous replications. In order to support the services in a real-time fashion, the Data-BE data must be accessible within a few milliseconds, even for large data sets. Thus the availability and redundancy mechanisms for the Data-BE implementation must be in-memory based.

Data-BE data may therefore be replicated at different Data-BE nodes in order to provide a replication mechanism in the event of failure of the “master” Data-BE node holding a particular subscriber's data. As subscriber data includes data that can change rapidly (examples of which include subscriber location, whether call-forwarding is turned on, sessions in which the subscriber is a participant), replication of subscriber data must be performed frequently.

A problem with known in-memory databases, where tight coupling between the different instances (master and slaves of the database is required, is that the signalling and data storage capacity increases where a higher level of redundancy is required, which drives the memory footprint required.

### SUMMARY

An object is to provide efficient ways of providing increased redundancy of Data-BE systems for a DLA network without greatly increasing the signalling bandwidth and footprint required. It is a further object to provide more efficient ways of providing redundancy of data.

According to a first aspect, there is provided a method of providing data redundancy in a data layered architecture (DLA) network. An enhanced redundancy data backend node (Data-BE) stores data designated as dynamic data in a computer readable medium in the form of a first memory. It also stores data designated as static data in any of a higher latency and higher volume computer readable medium in the form of a second memory.

In this way, data has a lower memory footprint, as only dynamic data need be regularly updated. However, the enhanced redundancy Data-BE node is able to reproduce all data (both static and dynamic) if required.

The data designated as static data is optionally stored on a non-volatile medium and data designated as dynamic data is optionally stored on a volatile medium.

The first memory optionally comprises a low latency memory medium and the second memory comprises a high storage volume memory medium.

In an optional embodiment, the enhanced redundancy Data-BE node receives data from a Data-BE node and applies at least one rule to the received data to categorize the received data into any of static data and dynamic data prior to storing the data. This allows the regular Data-BE node to send all data and the enhanced redundancy Data-BE node can decide which data is dynamic and which is static, and store it in the appropriate memory.

In an alternative option, the enhanced redundancy Data-BE node only receives from a Data-BE node data designated as dynamic data. This reduces signalling as only dynamic data need be sent.

As an option, the method further comprises sending the dynamic and the static data to an application front end node in the DLA network.

In an optionally embodiment, the data comprises subscriber data relating to a subscriber to the network. This is useful where, for example, the data is to be used by an HR-FE.

An optional way to categorize data as static data is to select data that is unlikely to change during a communication session.

According to a second aspect, there is provided a method of operating a Data-BE node in a DLA network. The Data-BE node sends data categorised as dynamic data to an enhanced redundancy Data-BE node for storing at the enhanced redundancy Data-BE node.

The Data-BE node optionally applies at least one rule to the data to categorize the data into any of static data and dynamic data prior to sending the dynamic data.

In an optional embodiment, the data comprises subscriber data relating to a subscriber to the network.

According to a third aspect, there is provided an enhanced redundancy Data-BE node for use in DLA network. The enhanced redundancy Data-BE node is provided with a receiver for receiving dynamic replication data from a Data-BE node. A first computer readable medium in the form of a memory is provided for storing the received dynamic replication data. A second computer readable medium in the form of a memory, having any of a higher latency and higher volume than the first memory, is provided for storing data categorized as static. A transmitter is also provided for sending stored data to an application front end node.

As an option, the second memory comprises a non-volatile memory and the first memory comprises a volatile memory.

The processor is optionally further arranged to categorize received data into any of static data and dynamic data prior to storing the data. This option is useful where the enhanced redundancy Data-BE node receives static data in addition to the dynamic data. However, in an alternative option, the receiver is optionally arranged to only receive data designated as dynamic data.

The data optionally comprises subscriber data relating to a subscriber to the network.

The receiver is optionally configured to receive data categorized as static. Furthermore, it may be arranged to receive information relating to changes to the static data.

According to a fourth aspect, there is provided a Data-BE node for use in a DLA network. The Data-BE node is provided with a computer readable medium in the form of a memory for storing data. A transmitter is also provided for sending to an enhanced redundancy Data-BE node at least a dynamic portion of the data for replicating at the enhanced redundancy Data-BE node.

The Data-BE node is optionally provided with a processor for applying at least one rule to the data to categorize the data into any of static data and dynamic data prior to sending the data.

As an option, the data comprises subscriber data relating to a subscriber to the network.

As a further option, the data may additionally include static data, or information relating to changes to the static data.

According to a fifth aspect, there is provided a computer program comprising computer readable code which, when run on an enhanced redundancy Data-BE node for use in a DLA network, causes the enhanced redundancy Data-BE node to behave as described above in the first aspect.

According to a sixth aspect, there is provided a computer program comprising computer readable code which, when run on a Data-BE node for use in a DLA network, causes the Data-BE node behave as described above in the second aspect.

According to a seventh aspect, there is provided a computer program product comprising a computer readable medium and a computer program as described above in the fifth or sixth aspects, wherein the computer program is stored on the computer readable medium.

### BRIEF DESCRIPTION OF THE DRAWINGS

FIG. 1 illustrates schematically in a block diagram a known exemplary Data Layered Architecture network;

FIG. 2 illustrates schematically in a block diagram an exemplary Data Layered Architecture network;

FIG. 3 is a flow diagram illustrating steps of an embodiment; and

FIG. 4 illustrates schematically in a block diagram an exemplary enhanced redundancy BE node; and

FIG. 5 illustrates schematically in a block diagram an exemplary Data-BE node.

### DETAILED DESCRIPTION

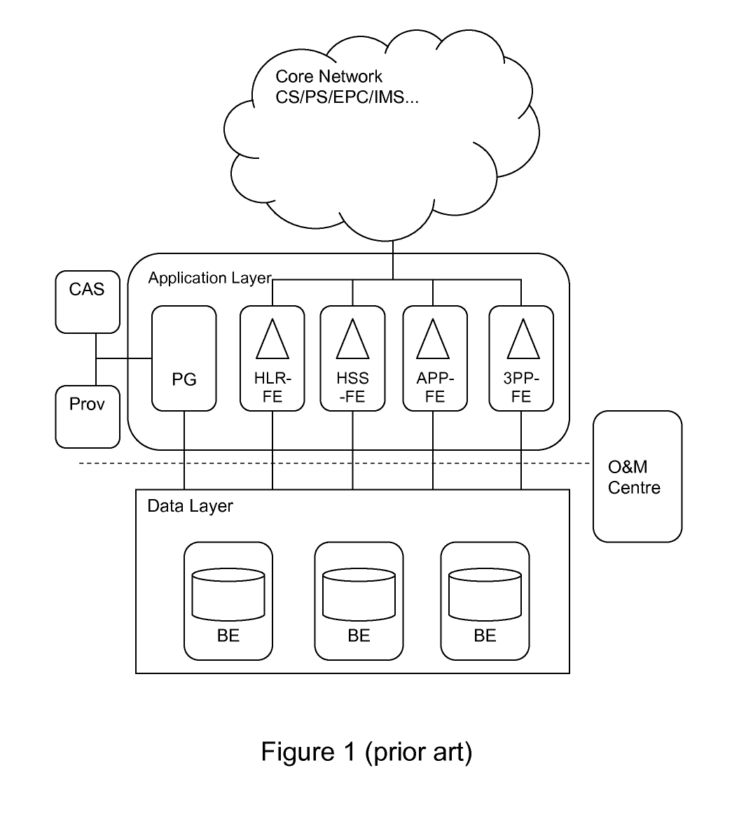

DLA has been outlined above with reference to FIG. 1. An approach will now be described that provides enhanced redundancy for data stored in a Data-BE by providing a further enhanced redundancy Data-BE node that can support several Data-BE nodes. The term enhanced redundancy Data-BE is referred to any node or combination of nodes that can provide enhanced redundancy of data as described below.

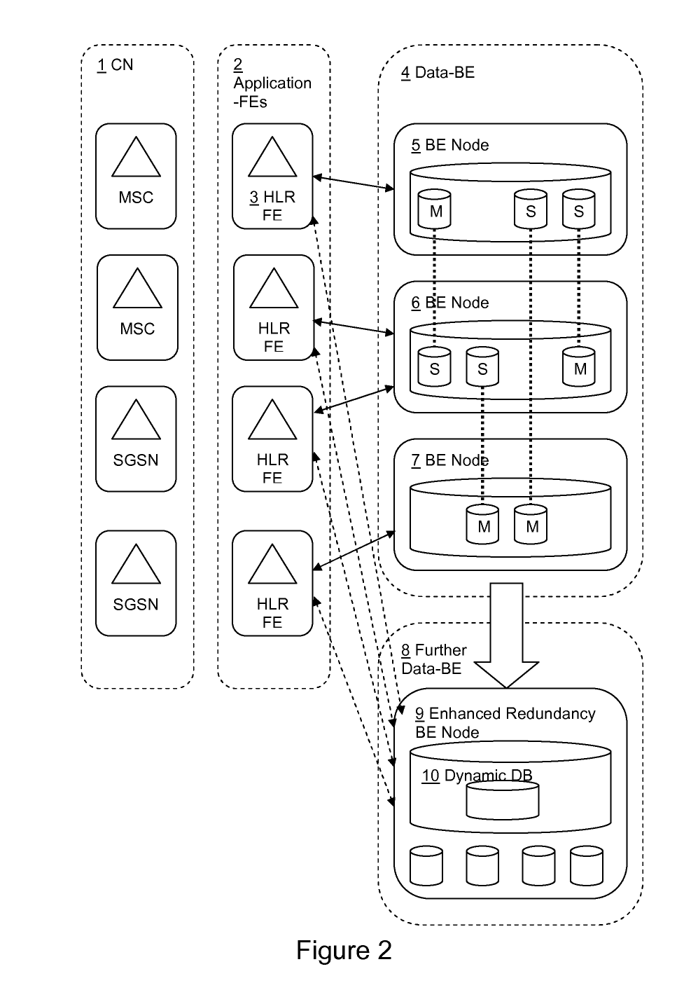

Referring to FIG. 2, there is illustrated a Core Network 1, an Application-FE layer 2 that includes, in this example, HLR-FEs 3 and a Data-BE 4 that includes three BE nodes 5, 6, 7. It can be seen that each BE node 5, 6, 7 stores one or more master (M) copy of data and may store one or more slaves (S). For example, BE node 5 stores a master copy of data that is replicated by BE node 6. BE node 6 stores a master copy of data that is replicated by BE node 5. BE node 7 stores two master copies of data, one of which is replicated by BE node 5, the other of which is replicated by BE node 7.

In the example where the data stored by the BE nodes is subscriber data, regular replications are made between the BE nodes using normal replication procedures.

However, under some circumstances a drastic failure of the BE nodes could lead to all subscriber data from all BE nodes 5, 6, 7 being unavailable, in which case the HLR-FEs 3 will not be able to provide HLR services to the subscribers. To address this, a further Data-BE system 8 that provides enhanced redundancy is proposed. It is proposed to operate the further Data-BE system in addition to the regular Data-BE 4, but it will be appreciated that the further Data-BE system could be operated instead of existing replication procedures.

It is proposed to categorise subscriber data as either static data or dynamic data. Static data includes data that does not change, or only changes rarely. Examples of static subscriber data include contact details, subscriber name, global preferences and so on. Examples of dynamic data include subscriber location, whether call forwarding is set, which sessions a subscriber is involved in and so on.

If, for example, the master data from BE node 5 is replicated at BE node 6, the replicated data is also sent to the enhanced redundancy BE node 9 at the further Data-BE 8. Enhanced redundancy BE node 9 only receives the dynamic data from the Data-BE node 5. Static data is provisioned either via a separate function or as part of a normal provisional process for a Data-BE. Static data is stored on a slower computer readable medium (typically a non-volatile medium such as a hard disk drive) than dynamic data. In an alternative embodiment, static data may also be sent periodically to the enhanced redundancy Data-BE node 9, although it is preferred that static data is already provisioned at the enhanced redundancy Data-BE node 9.

Dynamic data, on the other hand, is stored in a memory that allows much faster access (such as a volatile solid state memory) in a dynamic data database. The use of such a memory allows data replication with low latency, high transaction per second and with the normal redundancy requirements. This means that, for a given set of memory at the enhanced redundancy BE node 9, more dynamic data can be managed

The further Data-BE system 8 that only replicates the dynamic data can replicate from many database instances in the Data-BE system 4 and place the data in one database instance 10 in the extra BE system. This mitigates the strong coupling between replicas in a current in-memory database.

Since only the dynamic data is kept in the dynamic memory in the extra BE system while static data is stored on disk in the extra BE system, this leads to a reduced need of footprint for the added increased redundancy level.

In case of a disaster situation the enhanced redundancy BE node 9 at the further Data-BE system 8 will build the complete in-memory database for the chosen data set, using the static data from disk and the dynamic data from memory, and act as a normal in-memory database given the client low latency and high transaction per second characteristics. Note that under normal use, the further Data-BE system 8 will only be used for replication and will not be required to provide the data. This would typically be required in the event of a failure of all BE nodes 5, 6, 7 in the regular Data-BE system 4, but may also be used in the event of a failure of some of the BE nodes 5, 6, 7 in the regular Data-BE system 4.

Note the data to be replicated is categorised as dynamic or static, and the static data is provisioned at the enhanced redundancy Data-BE. This means that only the dynamic data need be sent during replication from a regular Data-BE node 5 to an enhanced redundancy BE-node 9. However, it is possible that the regular Data-BE node 5 sends all of the subscriber data to the enhanced redundancy Data-BE node 9, and the enhanced Data-BE node determines which data is static or dynamic before saving the dynamic data in the dynamic data database 10.

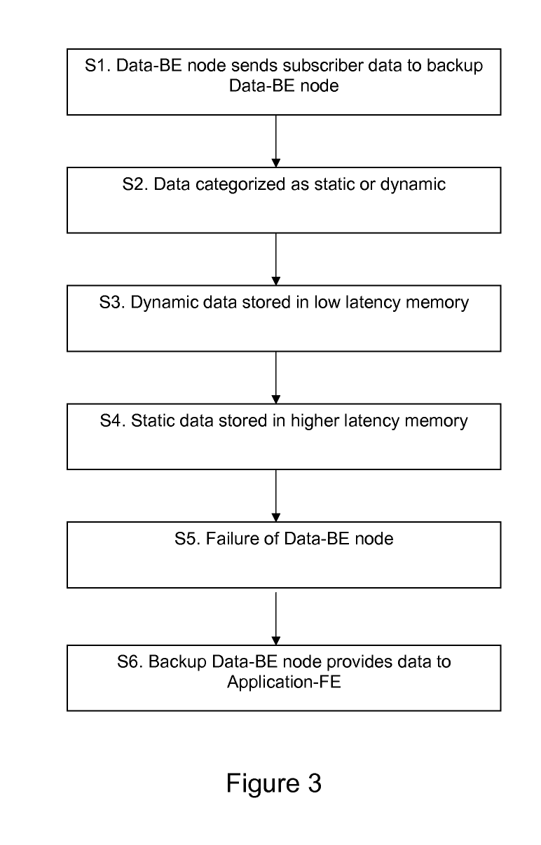

FIG. 3 is a flow diagram illustrating steps of an exemplary embodiment. The following numbering corresponds to that of FIG. 3.

S1. A Data-BE node 5 sends (typically dynamic) subscriber data to the enhanced redundancy Data-BE node 9 in addition to performing normal replication procedures with other Data-BE nodes 6, 7.

S2. The data is categorized as static or dynamic. Typically the Data-BE node 5 is configured to only send dynamic subscriber data, but note that the categorization may be performed by the enhanced redundancy Data-BE node 9 after receiving the data. If the categorization is performed by the Data-BE node 5, then it need only send dynamic subscriber data to the enhanced redundancy Data-BE node 9 for each replication. Static subscriber data need only be sent to the enhanced redundancy Data-BE node 9 periodically if at all, as it is typically already provisioned.

S3. The data categorized as dynamic data is stored in a low latency memory such as a solid state memory.

S4. The data categorized as static data is stored in a higher latency memory such as a hard disk or other type of non-volatile memory.

S5. The enhanced redundancy Data-BE 9 is not required unless there is a failure of one or more Data-BE nodes that hold the relevant subscriber data.

S6. In the event of a failure of one or more Data-BE nodes that hold the relevant subscriber data, the static data and dynamic data relevant to the subscriber is provided to an Application-FE node such as an HLR-FE 3 in the Application-FE layer 2. In this way, the failure of one or more Data-BE nodes 5, 6, 7 does not cause the HLR-FE 3 to lose the relevant subscriber data, and the fact that only the dynamic data is stored in a low latency memory assists in reducing the footprint of the enhanced redundancy Data-BE node 9.

Note that there are several ways in which subscriber data can be categorized as static or dynamic. For example, static data may be considered to be data that will not change during a session in which a subscriber participates. A series of rules may be applied to subscriber data to determine whether the data is static or dynamic.

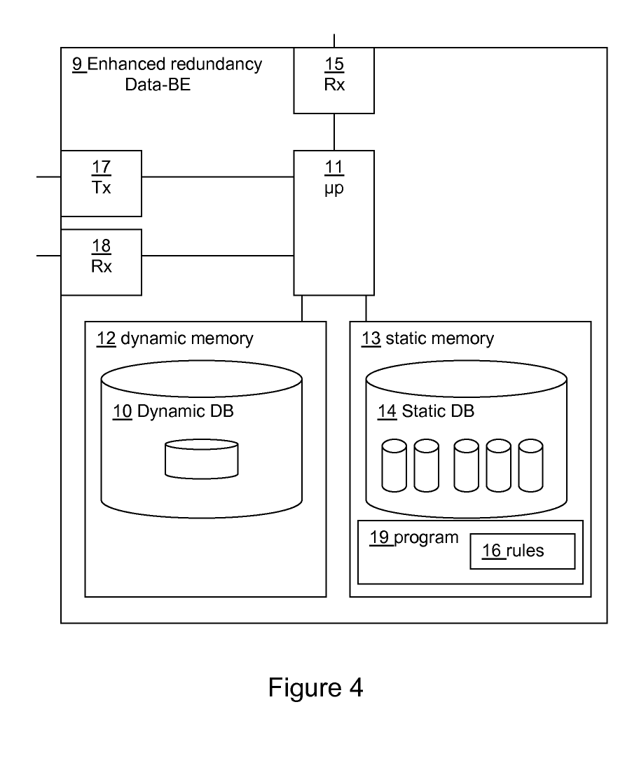

FIG. 4 illustrates schematically in a block diagram an enhanced redundancy Data-BE node 9 for use in a further Data-BE system 8. The enhanced redundancy Data-BE node 9 is provided with a processor 11 for message handling and determining where to store data. A computer readable medium in the form of a first memory 12 is provided for storing the dynamic data database 10, in which dynamic data is stored. The first memory has a low latency and is typically a volatile memory. A computer readable medium in the form of a second memory 13 having a higher latency is also provided for storing a static database 14 in which static subscriber data is stored. The second memory 14 is typically a non-volatile memory such as a hard disk, where latency is much higher than volatile memory.

The enhanced redundancy Data-BE node 9 is also provided with a receiver 15 for receiving subscriber data from a regular Data-BE node 5. In the event that the regular Data-BE node 5 is configured to only send dynamic data, the processor 11 simply stores the dynamic data in the appropriate memory 12. In the event that the regular Data-Be node 5 sends all subscriber data, the processor 11 applies rules 16 that may be stored at the enhanced redundancy Data-BE node 9 to categorize the subscriber data into static or dynamic data before storing the data in the appropriate memory 12, 13. Rules may, for example, include a table mapping different types of data to whether or not the data is categorized as static or dynamic. A transmitter 17 may also be provided for sending messages towards the regular Data-BE node. Note that the receiver 15 in one embodiment may comprise two physical receivers; one for receiving dynamic data and one for receiving static data. Of course, where the static data is preconfigured at the enhanced redundancy Data-BE node 9, the receiver may only receive dynamic data, or may receive occasional updates to static data,

The enhanced redundancy Data-BE node 9 is also provided with a transmitter 17 and receiver 18 for communicating with an HLR-FE 3 in the event that the HLR-FE 3 can no longer receive subscriber data from the regular Data-BE system 4. This allows the enhanced redundancy Data-BE node 9 to provide subscriber data directly to the HLR-FE when required, thereby allowing the HLR-FE 3 to be able to continue to service subscriber requests in the event of a failure of the regular Data-BE system.

The enhanced redundancy Data-BE node 9 may also be provided with a computer program 19 stored in a memory (shown in the static memory 13 in FIG. 4, but it will be appreciated that it may be stored in the dynamic memory 12, a further memory, or remotely). When executed by the processor 11, the program 11 causes the enhanced redundancy Data-BE node 9 to behave as described above.

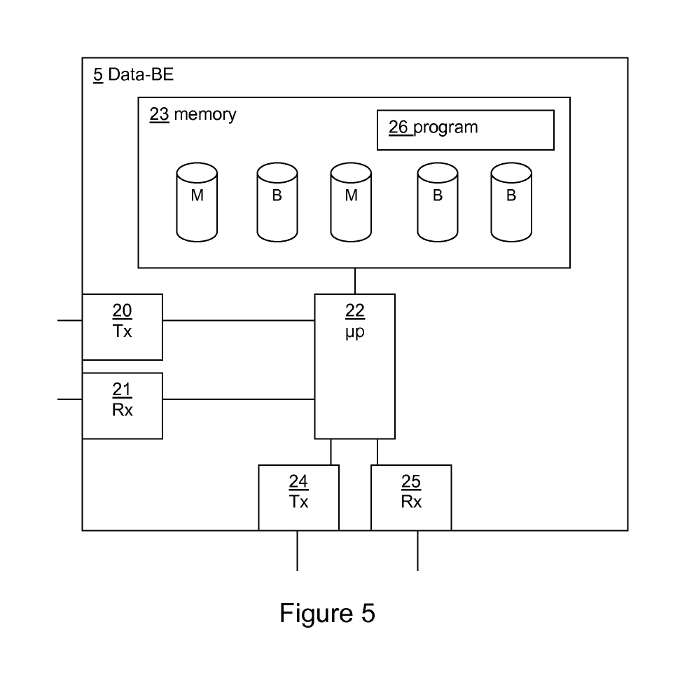

Note that the above FIG. 4 illustrates only a first memory 12 and a second memory 13, but it will be appreciated that each memory may be physically embodied as a plurality of memories. Also note that while a transmitters 17 and two receivers 15, 18 are shown in FIG. 5, they may be physically embodied in a plurality of transmitters or receivers, only one transmitter and receiver, or one or more transceivers. The structure of FIG. 4 is by way of example only.

Turning now to FIG. 5, there is illustrated an exemplary Data-BE node 5. The Data-BE node 5 is provided with a transmitter 20 and receiver 21 for communicating with an Application-FE node 3 that requires data such as subscriber data. A processor 22 is also provided for maintaining the subscriber data and handling messages. A computer readable medium in the form of a memory 23 is provided for storing one or more databases of subscriber data. A second transmitter 24 and a second receiver 25 are provided for communicating with other Data-BE nodes to perform regular replications of subscriber data, and also for communicating with the enhanced redundancy Data-BE node 9 to perform a replication as described above.

The processor 22, in one embodiment, is arranged to categorize the subscriber data as either dynamic or static and only send the dynamic data to the enhanced redundancy Data-BE node 9. Alternatively, the processor may send all of the subscriber data directly to the enhanced redundancy Data-BE node 9.

In a further embodiment, where the enhanced redundancy Data-BE 9 is pre-provisioned with static data, the processor 22 may be further arranged to determine when static data at the Data-BE 5 has changed and, in addition to notifying the Data-BE 5 of dynamic data, also notify the enhanced redundancy Data-BE 9 of changes to static data. In this way, the enhanced redundancy Data-BE 9 can maintain up to date static data, and signalling is minimized, as only changes to static data are communicated.

The memory 23 may also be used to store a computer program 26 which, when executed by the processor 22, causes the Data-BE node 5 to behave as described above.

Note that the above description refers to only one memory, but it will be appreciated that the memory may be physically embodied as a plurality of memories. Also note that while two transmitters 20, 24 and two receivers 21, 25 are shown in FIG. 5, they may be physically embodied in a plurality of transmitters or receivers, only one transmitter and receiver, or one or more transceivers. The structure of FIG. 5 is by way of example only.

The replication techniques described above allow a Data-BE in a DLA to have increased redundancy but at minimal cost to memory and processing required.

It will be appreciated by the person of skill in the art that various modifications may be made to the above described embodiment without departing from the scope of the present invention. For example, the functions of the various nodes are described as being embodied at a single node, but it will be appreciated that different functions may be provided at different network nodes.

The following abbreviations have been used in this application:

### BE Back end

### CN Core Network

CS circuit switched

### DLA Data Layered Architecture

### EPC Evolved Packet Core

### FE Front end

### GRPS General Packet Radio Service

### HLR Home Location Register

### IMS IP Multimedia Subsystem

### LTE Long Term Evolution

### MSC Mobile Switching Centre

O&M Operations & Maintenance centre

### PLMN Public Land Mobile Network

PS packet switched

### SGSN Serving GPRS Support Node

### SIM Subscriber Identity Module

VLR Visitor Location Register

1. A method of providing data redundancy in a data layered architecture network, the method comprising:
at an enhanced redundancy data backend node, storing data designated as dynamic data in a computer readable medium in the form of a first memory; and
at the enhanced redundancy data backend node, storing data designated as static data in any of a higher latency and higher volume computer readable medium in the form of a second memory.

2. The method according to claim 1, comprising storing the data designated as static data on a non-volatile medium and comprising storing the data designated as dynamic data on a volatile medium.

3. The method according to claim 1, wherein the first memory comprises a low latency memory medium and the second memory comprises a high storage volume memory medium.

4. The method according to claim 1, further comprising:
at the enhanced redundancy data backend node, receiving from a data backend node data;
applying at least one rule to the received data to categorize the received data into any of static data and dynamic data prior to storing the data.

5. The method according to claim 1, further comprising:
at the enhanced redundancy data backend node, receiving from a data backend node only data designated as dynamic data.

6. The method according to claim 1, further comprising:
sending the dynamic and the static data to an application front end node in the data layered architecture network.

7. The method according to claim 1, wherein the data comprises subscriber data relating to a subscriber to the network.

8. The method according to claim 1, where data is categorized as static data in the event that it is unlikely to change during a communication session.

9. A method of operating a data backend node in a data layered architecture network, the method comprising:
at the data backend node, sending to an enhanced redundancy data backend node data categorised as dynamic data for storing at the enhanced redundancy data backend node.

10. The method according to claim 9, further comprising:
applying at least one rule to the data to categorize the data into any of static data and dynamic data prior to sending the data.

11. The method according to claim 9, wherein the data comprises subscriber data relating to a subscriber to the network.

12. An enhanced redundancy data back end node for use in data layered architecture network, the enhanced redundancy data back end node comprising:
a receiver for receiving dynamic replication data from a data back end node;
a first computer readable medium in the form of a memory for storing the received dynamic replication data;
a second computer readable medium in the form of a memory having any of a higher latency and higher volume than the first memory for storing data categorized as static; and
a transmitter for sending stored data to an application front end node.

13. The enhanced redundancy data back end node according to claim 12, wherein the second memory comprises a non-volatile memory and the first memory comprises a volatile memory.

14. The enhanced redundancy data back end node according to claim 12, wherein the processor is further arranged to categorize the received data into any of static data and dynamic data prior to storing the data.

15. The enhanced redundancy data back end node according to claim 12, wherein the receiver is arranged to only receive data designated as dynamic data.

16. The enhanced redundancy data back end node according to claim 12, wherein the data comprises subscriber data relating to a subscriber to the network.

17. The enhanced redundancy data back end node according to claim 12, wherein the receiver is further configured to receive data categorized as static.

18. A data back end node for use in a data layered architecture network, the data back end node comprising:
a computer readable medium in the form of a memory for storing data;
a transmitter for sending to an enhanced redundancy data backend node at least a dynamic portion of the data for replicating at the enhanced redundancy data backend node.

19. The data back end node according to claim 18, further comprising:
a processor for applying at least one rule to the data to categorize the data into any of static data and dynamic data prior to sending the data.

20. The data back end node according to claim 18, wherein the data comprises subscriber data relating to a subscriber to the network.

21. A computer program, comprising computer readable code which, when run on an enhanced redundancy data back end node for use in a data layered architecture network, causes the enhanced redundancy data back end node to perform the method of claim 1.

22. A computer program, comprising computer readable code which, when run on a data back end node for use in a data layered architecture network, causes the data back end node to perform the method of claim 9.

23. A computer program product comprising a computer readable medium and a computer program according to claim 21, wherein the computer program is stored on the computer readable medium.
